(19) United States
(12) Patent Application Publication
(10) Pub. No.: US 2009/0228391 A1
(43) Pub. Date: Sep. 10, 2009

(54) Methods To Advance Loan Proceeds On Prepaid Cards, Associated Systems And Computer Program Products

(76) Inventors: Trent Sorbe, Brookings, SD (US); Troy Larson, Brandon, SD (US); Rebecca Ahlers, Cincinnati, OH (US)

Correspondence Address: BRACEWELL & GIULIANI LLP, P.O. BOX 61389, HOUSTON, TX, 77208-1389, US

(21) Appl. No.: 12/389,749

(22) Filed: Feb. 20, 2009

Related U.S. Application Data
(60) Provisional application No. 61/029,975, filed on Feb. 20, 2008.
(60) Provisional application No. 61/052,454, filed on May 12, 2008.
(60) Provisional application No. 61/042,612, filed on Apr. 4, 2008.
(60) Provisional application No. 61/042,624, filed on Apr. 4, 2008.
(60) Provisional application No. 61/032,750, filed on Feb. 29, 2008.
(60) Provisional application No. 61/060,559, filed on Jun. 11, 2008.
(60) Provisional application No. 61/082,863, filed on Jul. 23, 2008.
(60) Provisional application No. 61/053,056, filed on May 14, 2008.

(51) Int. Cl. G06Q 40/00; H04L 9/32; G06F 21/00

(52) U.S. Cl. 705/38; 726/7

(57) ABSTRACT

Embodiments of the present invention include systems, computer program products, and associated computer-implemented methods of advancing loan proceeds on prepaid cards. Example embodiments include generating a common interface for loan information when proceeds from the loan are destined for a prepaid card account. As understood by those skilled in the art, the common interface of the embodiments of the present invention is agnostic to the prepaid card processor. Example embodiments include determining the prepaid card processor associated with the prepaid card account from the loan information provided through the common interface and invoking the prepaid processor as one of the plurality of preselected prepaid processors available to post the loan proceeds to the prepaid card account. Example embodiments further include reconciling the information for the approved loan from the underwriter with the information from the prepaid card processor.

### RELATED APPLICATIONS

This application claims priority to and the benefit of U.S. Provisional Patent Application No. 61/029,975, titled “Methods to Advance Loan Proceeds on Prepaid Cards, Associated Systems and Computer Program Products”, filed on Feb. 20, 2008, incorporated herein by reference in its entirety. This application relates to: U.S. Provisional Patent Application Ser. No. 61/052,454, by Sorbe et al., titled “Transfer Account Systems, Computer Program Products, and Methods to Prioritize Payments from Preselected Bank Account” filed May 12, 2008; U.S. Provisional Patent Application Ser. No. 61/042,612, by Ahlers et al., titled “System, Program Product, and Associated Methods To Autodraw for Micro-Credit Attached to a Prepaid Card” filed on Apr. 4, 2008; U.S. Provisional Patent Application Ser. No. 61/042,624, by Crowe et al., titled “System, Program Product, and Method To Authorize Draw for Retailer Optimization” filed on Apr. 4, 2008; U.S. Provisional Patent Application Ser. No. 61/032,750, by Ahlers et al., titled “Methods, Program Product, and System for Micro-Loan Management” filed on Feb. 29, 2008; U.S. Provisional Patent Application Ser. No. 61/060,559, by Galit et al., titled “Methods, Program Product, and System to Enhance Banking Terms Over Time” filed on Jun. 11, 2008; U.S. Provisional Patent Application Ser. No. 61/082,863, by Ahlers et al., titled “System, Program Product, and Method For Debit Card and Checking Account Autodraw” filed on Jul. 23, 2008; U.S. Provisional Patent Application Ser. No. 61/053,056, by Galit et al., titled “System, Program Product, and Method For Loading a Loan On a Pre-Paid Card” filed on May 14, 2008, all of which are each incorporated herein by reference in their entireties. This application also relates to: U.S. patent application Ser. No. 12/338,584, by Sorbe et al., titled “Transfer Account Systems, Computer Program Products, and Computer-Implemented Methods to Prioritize Payments from Preselected Bank Account” filed Dec. 18, 2008; U.S. patent application Ser. No. 12/338,645, by Sorbe et al., titled “Transfer Account Systems, Computer Program Products, and Computer-Implemented Methods to Prioritize Payments from Preselected Bank Account” filed Dec. 18, 2008; U.S. patent application Ser. No. 12/338,684, by Ahlers et al., titled “Computer-Implemented Methods, Program Product, and System for Micro-Loan Management” filed on Dec. 18, 2008; PCT/US08/87660 by Ahlers et al., titled “Computer-Implemented Methods, Program Product, and System for Micro-Loan Management” filed on Dec. 19, 2008; U.S. patent application Ser. No. 12/338,712, by Galit et al., titled “Computer-Implemented Methods, Program Product, and System to Enhance Banking Terms Over Time” filed on Dec. 18, 2008; and PCT/U508/87689 by Galit et al., titled “Computer-Implemented Methods, Program Product, and System to Enhance Banking Terms Over Time” filed on Dec. 19, 2008, all of which are each incorporated herein by reference in their entireties.

### BACKGROUND

1. Field of Invention

The present invention relates generally to the financial service and banking industries, and, more particularly, to systems, computer program products, and associated computer-implemented methods to advance loan proceeds on prepaid cards.

2. Background

It is known that millions of prepaid cards are issued each year in the United States. It is also known that many of the customers of prepaid cards rely primarily on cash and a prepaid card account for their personal finances; these customers often do not have a traditional checking, savings, or other bank deposit account, and they usually do not write checks.

It is further known that payroll proceeds, state and federal government benefits, and other forms of direct or automatic deposits can be credited to, or posted to, many prepaid card accounts. In addition, it is known that a retailer can post proceeds to many of these accounts, typically for a fee. For example, a customer can bring $150 in cash into a retailer; the retailer receives the cash and posts the value of the cash, minus a fee, to the customer's prepaid card account. Thereafter, the customer can use the money in the prepaid card account to purchase goods or pay bills, either in person or electronically via the internet, a kiosk, or a telephone.

It is also known that proceeds from a loan can be credited to or posted to a prepaid card. For example, PPI of Irvine, Calif. will post loan proceeds to a prepaid card account associated with FSV Payment Systems, Inc., a Houston-based prepaid card processor. Each of the several prepaid card processors, however, provides a different interface. Thus, today's solutions for advancing loan proceeds on a prepaid card, at best, are specific to a particular card processor. As a result, a lender may offer a loan to those prepaid card customers, if at all, associated only with a specific prepaid card processor.

### SUMMARY OF INVENTION

Applicant has identified that the different interfaces of the existing prepaid card processors are a source of problems with advancing loan proceeds on a scalable volume of prepaid cards. For example, these different interfaces can add complexity and can needlessly limit the ability of a lender to make loans widely available to customers with prepaid cards. An interface is defined as a boundary across which two systems interact or communicate, including the software codes and data formats that applications use to communicate, as understood by those skilled in the art. From a customer's point of view, it is desirable to be able to apply for a loan and have access to the proceeds without having to collect the loan proceeds in person. Likewise, lenders would like to be able to offer loans and advance the proceeds conveniently, without concerning retail space for the delivery of the proceeds. Also from a customer's point of view, it is desirable for multiple lenders to be able to compete for the customers business. From a lender's perspective, it is desirable to be able to make a loan to anyone with a loadable prepaid card, without regard to the specific prepaid card processor associated with the customer's prepaid card. Moreover, it is desirable from a lender's perspective to post loan proceeds through multiple prepaid card processors, yet mask the complexity of interacting with various interfaces by utilizing a single, common interface. In addition to broadening the market of lenders to prepaid card accounts, the results of a common interface are reduced error rates and training costs. In view of the foregoing, Applicant provides computer-implemented methods to advance loan proceeds on prepaid cards, and associated systems and computer program products.

Embodiments of the present invention include generating a common interface for loan information when proceeds from the loan are destined for a prepaid card account. As understood by a person having ordinary skill in the art, the common interface of the embodiments of the present invention is agnostic to the prepaid card processor. That is, the common interface covers, works with, or feeds various prepaid card processors, as understood by those skilled in the art. Therefore, the information provided through the common interface will enable the advancing of loan proceeds to prepaid card accounts associated with a plurality of prepaid card processors.

Embodiments of the present invention include a computer-implemented method of advancing loan proceeds on a prepaid card, Under the computer-implemented method, a lending institution computer generates a common interface for information for an approved loan to an underwriter for loans when proceeds from the loan are destined for a prepaid card account. After approving the customer's loan request, the underwriter provides loan information through the common interface to the lending institution. Next, the lending institution computer determines a prepaid card processor associated with the prepaid card account from the loan information provided through the common interface. For example, the prepaid card account number can map to a prepaid card processor, as understood by those skilled in the art. Having determined the appropriate prepaid card processor, the computer associated with the lending institution, known as the bank computer, invokes the prepaid card processor as one of a plurality of preselected processors available to post the loan proceeds to the prepaid card account. Once the loan proceeds are posted, the borrower has access to the proceeds through the prepaid card. The computer-implemented method further includes the bank computer reconciling the information for the approved loan from the underwriter with the information from the prepaid card processor.

Embodiments of the present invention also can include selling the loan obligations by the lending institution, as understood by one skilled in the art.

Embodiments of the present invention include a computer program product to implement the methods described and shown. Embodiments of the present invention include a computer program product, stored on a tangible computer memory media that is readable by a computer, for advancing loan proceeds to a prepaid card account, the computer program product comprising a set of instructions that, when executed by the computer, cause the computer to perform various operations. The operations include a bank computer generating a common interface for information for an approved loan to an underwriter computer where proceeds from the loan are destined for a prepaid card account. The operations continue with determining the prepaid card processor associated with the prepaid card account from the loan information provided, as understood by those skilled in the art. Next, the bank computer invokes the appropriate processor-specific software methods available from the prepaid card processor associated with the prepaid card account to post the loan proceeds to the prepaid card account. Then operations also include the bank computer reconciling the information for the approved loan from the underwriter computer with the information from the prepaid card processor.

A computer program product, according to an embodiment of the present invention, can include various modules or components. For example, the computer program product can include a common interface module to interact and communicate with one or more underwriter computers, e.g., to receive data for an approved loan. The computer program product can also include, for example, a prepaid card taxonomy module to classify prepaid cards according to an associated prepaid card processor using a portion of the prepaid card serial number; the taxonomy module can also, for example, manage a database of prepaid card files. The computer program product can also include, for example, a format translator module. Responsive to communication from the taxonomy module, the format translator module can invoke the associated prepaid card processor for a given prepaid card, convert the data received by the common interface into a processor-specific instruction format, and communicate the converted data to the prepaid card processor. In addition, the computer program product can also include, for example, a reconciliation module to receive data, e.g., flat files, or data files that have no structural relationship as understood by those skilled in the art, from the format translator module, the underwriter computer, and the prepaid card processor. The reconciliation module can also, for example, compare the various data files to reconcile the data and check for errors.

In addition, embodiments of the present invention include improvements and enhancements for systems, computer program products, and associated computer-implemented methods of advancing loan proceeds to prepaid card accounts through a single common interface, the interface agnostic to the prepaid card processor, as will be understood by those skilled in the art.

### BRIEF DESCRIPTION OF DRAWINGS

So that the manner in which the features and benefits of the invention, as well as others which will become apparent, may be understood in more detail, a more particular description of the invention briefly summarized above may be had by reference to the embodiments thereof which are illustrated in the appended drawings, which form a part of this specification. It is also to be noted, however, that the drawings illustrate only various embodiments of the invention and are therefore not to be considered limiting of the invention's scope as it may include other effective embodiments as well.

FIG. 1 is a table illustrating method availability by prepaid card processor according to an embodiment of the present invention;

FIG. 2 is a schematic flow diagram illustrating software architecture according to an embodiment of the present invention;

FIG. 3 is a schematic flow diagram of a computer-implemented method to advance loan proceeds to a prepaid card account according to another embodiment of the present invention;

FIG. 4A is a schematic block diagram of a system to advance loan proceeds to a prepaid card account according to an embodiment of the present invention;

FIG. 4B is a schematic diagram of a loan set up flow according to an embodiment of the present invention;

FIG. 5 is a schematic block diagram of a computer having a computer readable medium according to another embodiment of the present invention;

FIG. 6 is a front plan view of a display screen of a computer displaying an online application according to an embodiment of the present invention;

FIG. 7 is a front plan view of a display screen of a computer displaying an excerpt of transaction history statement according to an embodiment of the present invention;

FIGS. 8A and 8B are respective front and rear views of a prepaid card according to an embodiment of the present invention; and

FIG. 9 is a front plan view of a display screen of an access interface device displaying a text message of an account balance according to an embodiment of the present invention.

### DETAILED DESCRIPTION OF INVENTION

The present invention will now be described more fully hereinafter with reference to the accompanying drawings, which illustrate embodiments of the invention. This invention may, however, be embodied in many different forms and should not be construed as limited to the illustrated embodiments set forth herein; rather, these embodiments are provided so that this disclosure will be thorough and complete, and will fully convey the scope of the invention to those skilled in the art. Like numbers refer to like elements throughout.

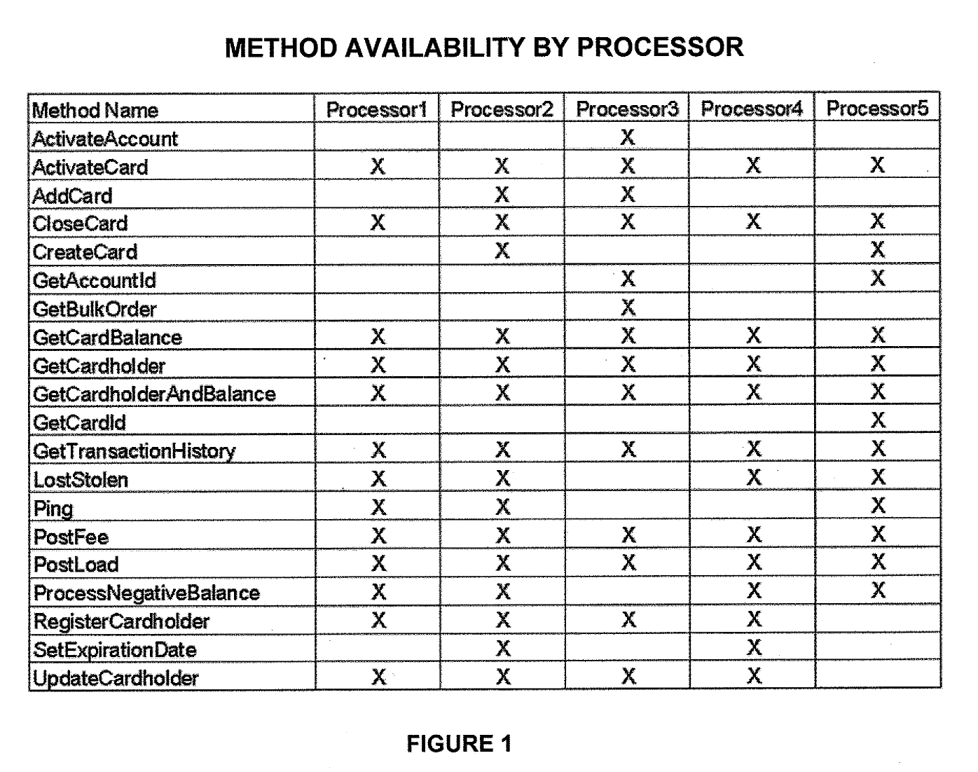

Applicant has identified that the different interfaces of the existing prepaid card processors, as illustrated in FIG. 1, are a source of problems with advancing loan proceeds on prepaid cards. Note that no two prepaid card processors provide the same method availability, and that no prepaid card processor supports every method. Collectively, the various interfaces add complexity, needlessly limit the ability of a lender to make loans available to customers with prepaid cards, increase the error rate for such loan processing, and result in higher training costs for loans associated with prepaid card accounts. Embodiments of the present invention provide a solution to these problems in the context for advancing loan proceeds to a prepaid card.

Embodiments of the present invention include generating a common interface for loan information when proceeds from the loan are destined for a prepaid card account. As understood by a person having ordinary skill in the art, the common interface of the embodiments of the present invention is agnostic to the prepaid card processor. That is, the common interface works with a plurality of prepaid card processors, including but not limited to, for example, FDR, FSV, Galileo, Symmetrex, and TSYS prepaid card processors, for example, as understood by those skilled in the art. First Data Corporation, formerly First Data Resources, (FDR) is a transaction processing company, including prepaid cards, and is headquartered in Greenwood Village, Colo., as understood by those skilled in the art. FSV Payment Systems, Inc. (FSV) provides prepaid technology and stored value processing and is headquartered in Houston, Tex., as understood by those skilled in the art. Galileo Processing, Inc. (Galileo) is a privately held, financial payment processing company based out of Salt Lake City, Utah, as understood by those skilled in the art. Symmetrex, Inc. (Symmetrex) is a transaction processing company and a large prepaid card processor in the United States, located in Maitland, Fla., as understood by those skilled in the art. With headquarters located in Columbus, Ga., Total System Services, Inc. (TSYS) provides electronic payment services to financial institutions and companies, including consumer-finance, credit, debit, healthcare, loyalty, prepaid, chip and mobile payments, as understood by those skilled in the art.

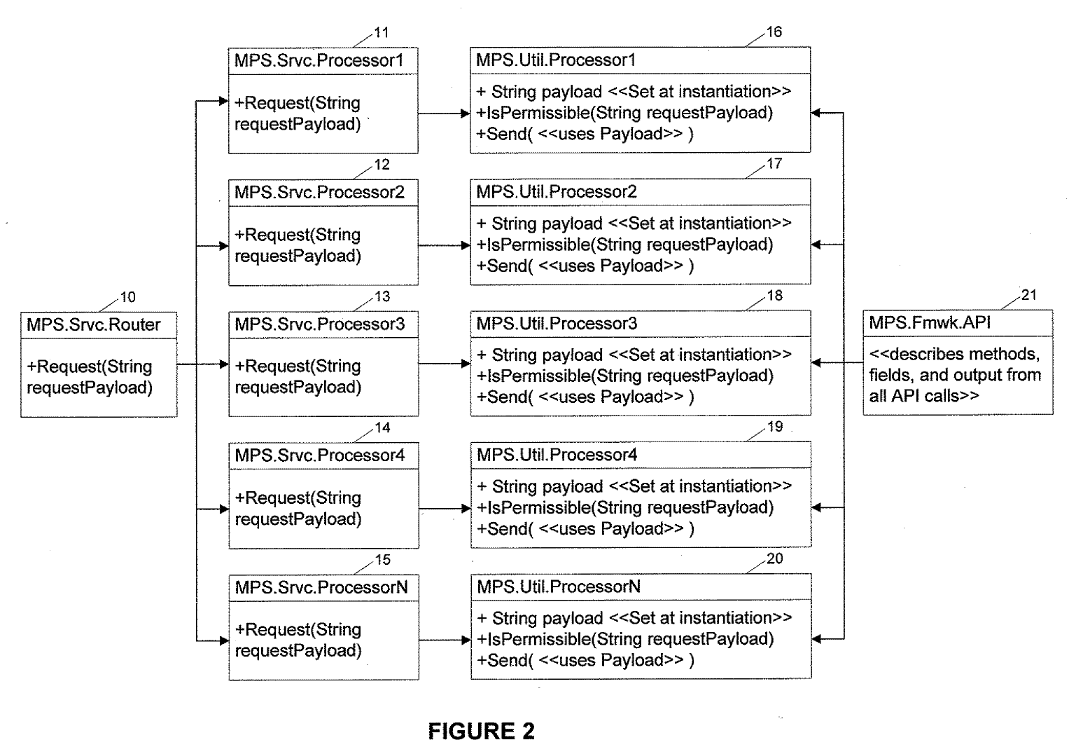

In an exemplary embodiment of the present invention, the common interface is generated by a computer program product running on a computer associated with a lending institution. The lending institution computer acts a gateway between the computer of the underwriter and the prepaid card processor. Under the ‘forwarder’ software architecture for the services provided, as illustrated in FIG. 2, the lending institution computer forwards loan information from the underwriter computer to the prepaid card processors, keeping the entry point of information the same while differentiating the processor-specific implementations. Separation of the processor-specific implementation or resources allows for client software, for example, client software associated with the underwriter computer, to remain agnostic to the eventual endpoint. In this exemplary embodiment of the present invention, the gateway contains a single ‘Request’ method, or request, accepting an XML payload. As understood by one skilled in the art, the payload contains a section for message content, a section for a description of the message content, and a section for exception information pertaining to the message. In this exemplary embodiment, the processor servicing gateways are further broken out to utility libraries to maintain a loosely coupled relationship with SOAP and processor implementations. Utilities maintain ‘rules’ and ‘definitions’ within a framework defining the calls, methods, inputs, outputs, and basic entity models, as shown in 21. MPS.Srvc.Router 10 provides the common interface. MPS.Srvc.<<processorName>> 11-15 provide gateway functionality to the prepaid card processor. MPS.Util.<<processorNane>> 16-20 provide the processor-specific implementation. As understood by those having skill in the art, there are numerous ways and variations for implementing the present invention.

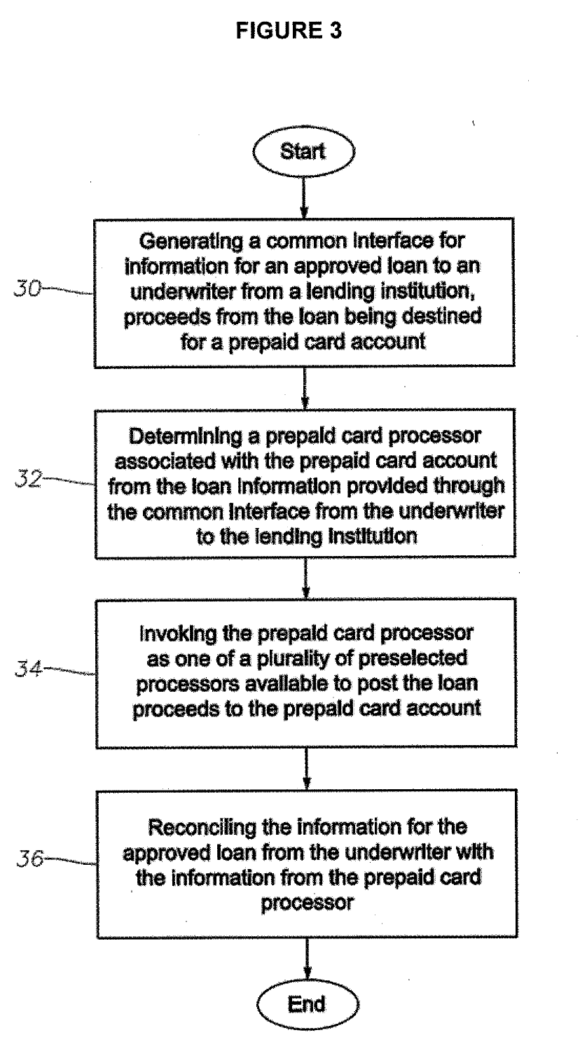

Embodiments of the present invention include a computer-implemented method of advancing loan proceeds on a prepaid card, as illustrated in FIG. 3. Under the computer-implemented method, a lending institution computer generates a common interface for information for an approved loan to an underwriter computer for loans when proceeds from the loan are destined for a prepaid card account (block 30). After approving the customer's loan request, the underwriter computer provides loan information through the common interface to the lending institution computer Because of the common interface, the information provided is agnostic to the prepaid card processor to be used. Next, the lending institution computer determines a prepaid card processor associated with the prepaid card account from the loan information provided through the common interface (block 32). Having determined the appropriate prepaid card processor, the bank computer invokes the prepaid card processor as one of a plurality of preselected processors available to post the loan proceeds to the prepaid card account (block 34). Once the loan proceeds are posted, the borrower has access to the proceeds through the prepaid card. The computer-implemented method further includes the bank computer reconciling the information for the approved loan from the underwriter with the information from the prepaid card processor (block 36).

Reconciling the information for the approved loan from the underwriter computer with the information from the prepaid card processor is a form of error-checking for the entire process. For example, if the underwriter computer indicates an approved loan of certain amount destined for a prepaid card account and the prepaid card processor indicates a posting of that certain amount at the same date and near the same time, then reconciling the information provides confirmation of success; there is no error. However, in another example, if the underwriter computer indicates an approved loan of certain amount destined for a prepaid card account and the prepaid card processor indicates a posting of a different amount at the same date and near the same time, then reconciling the information provides an error, in this case of the amount. As understood by those skilled in the art, a bank computer reconciling the information for the approved loan from the underwriter computer with the information from the prepaid card processor can provide numerous and different types of errors.

Embodiments of the present invention further include the selling the loan obligations by the lending institution, as understood by one skilled in the art. For example, the lending institution computer can bundle or package the loan obligations so that the lending institution can provide more loans than its lending capacity, as determined by regulations and as understood by those skilled in the art.

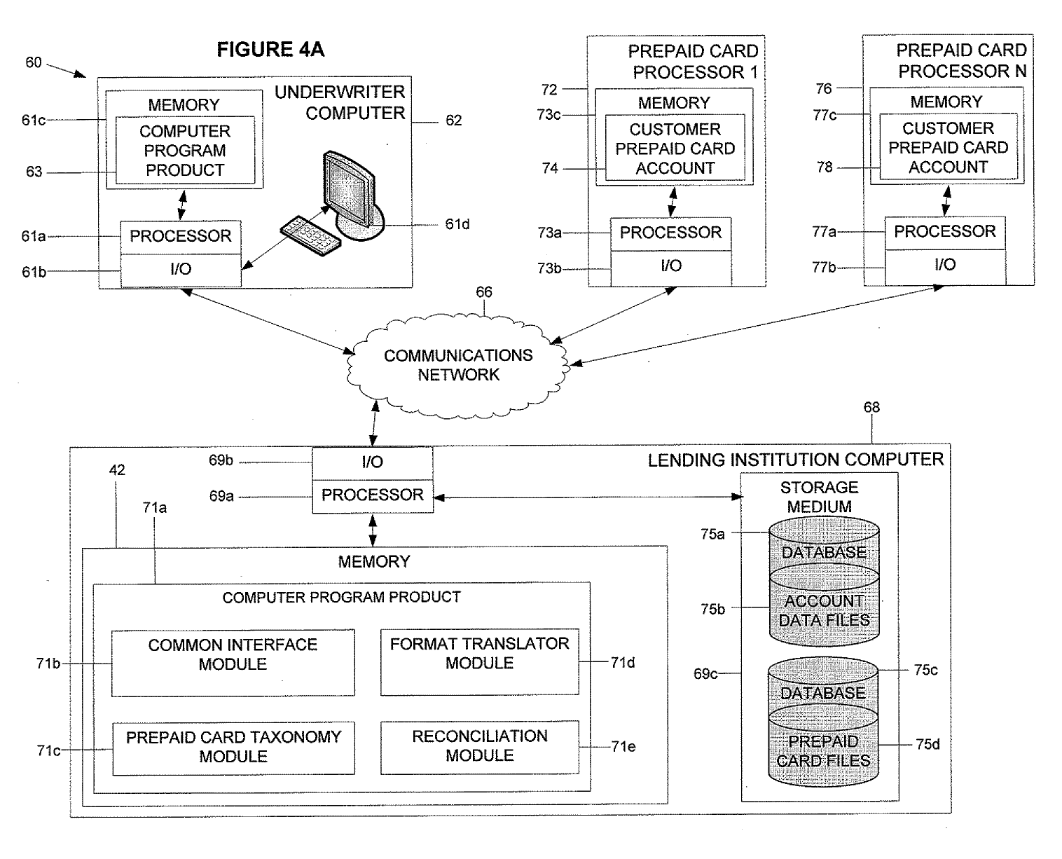

Embodiments of the present invention also provide a system a system 60 to advance loan proceeds on a prepaid card, as illustrated in FIG. 4A. The system 60 includes a first computer associated with an underwriter defining an underwriter computer 62. The underwriter computer can have one or more processors 61a, input/output (I/O) devices 61b, memory 61c, and an optional display 61d. The memory 61c of the underwriter computer 62 can include computer program products 63 associated with receiving and approving a loan application. The underwriter computer 62 can provide information for a loan, or loan data, through an electronic communications network 66 to a second computer associated with a lending institution defining a bank computer 68. That is, the underwriter computer 62 determines whether to approve a loan responsive to the loan application and sends the approved loan information to the bank computer 68. The bank computer 68 can have one or more processors 69a, input/output (I/O) devices 69b, memory 42, an optional display, and storage media 69c. The bank computer 68 receives and processes loan information from the underwriter computer 62 utilizing a computer program product 71a described herein. The system 60 also includes a plurality of third computers associated with customer prepaid card accounts 74, 78 defining prepaid card processors 72, 76. The prepaid card processors 72, 76 can each have one or more processors 73a, 77a, input/output (I/O) devices 73b, 77b, and memory 73c, 77c. The prepaid card processors 72, 76 receive posting information from the bank computer 68 through the electronic communications network 66 and, responsive to a post, credit loan proceeds to a prepaid card account 74, 78.

Note that although specification describes and illustrates the underwriter and the lending institution as distinct and separate entities, those skilled in the art recognize that the underwriter and the lending institution may be the same entity and that the underwriter computer 62 may be the same as the bank computer 68. That is, whether the underwriting functionality is performed “in-house” at the lending institution, or otherwise, is not a limitation of the present invention, as understood by those skilled in the art.

The embodiments of the present invention also include a computer program product 71a, as illustrated in FIGS. 4A and 4B, associated with the bank computer 68, stored on a tangible computer memory media 42, operable on a computer, and used to advance loan proceeds to a prepaid card account 74, 78. The computer program product 71a can include various modules, or components, where each module is associated with a computer, stored on a tangible computer memory media and operable on a computer, and includes a set of instructions that, when executed by the computer, cause the computer to perform various operations. For example, the computer program product 71a can include a common interface module 71b associated with the bank computer 68, stored on a tangible computer memory media and operable on a computer; the common interface module can include a set of instructions that, when executed by the computer, cause the computer to perform the operation of receiving data for an approved loan from one or more underwriter computers 62, where the proceeds from the loan are destined for a prepaid card account 74, 78. The computer program product 71a can include, for example, a prepaid card taxonomy module 71c associated with the bank computer 68, stored on a tangible computer memory media and operable on a computer. The prepaid card taxonomy module 71c can include a set of instructions that, when executed by the computer, cause the computer to classify prepaid cards according to an associated prepaid card processor, to maintain and manage a database 75c of prepaid card files 75d that associates prepaid cards with prepaid card processors, and to determine a prepaid card processor associated with the prepaid card account from loan data provided through the common interface module 71b from the underwriter computer 62 responsive to a prepaid card serial number. The computer program product 71a can include, for example, a format translator module 71d associated with the bank computer 68, stored on a tangible computer memory media and operable on a computer. The format translator module 71d can include a set of instructions that, when executed by the computer, cause the computer to invoke the associated prepaid card processor 76 for a given prepaid card responsive to the determination of the taxonomy module 71c, to convert the loan data received by the common interface module 71b into a processor-specific instruction format, and to communicate the converted loan data to the prepaid card processor 76 to post the loan proceeds to the prepaid card account 78 so that a first data format is converted into a second data format to thereby enable the posting of the loan proceeds to the prepaid card and so that the loan application is converted into a prepaid card having an associated value and being capable of purchasing goods. The computer program product 71a can include, for example, a reconciliation module 71e associated with the bank computer 68, stored on a tangible computer memory media and operable on a computer. The reconciliation module 71e can include a set of instructions that, when executed by the computer, cause the computer to receive and compare data for the approved loan, e.g., flat files 79a, 79b, 79c, or data files that have no structural relationship as understood by those skilled in the art, from the underwriter computer 62, from the prepaid card processor 76, and the format translator module 71d. The reconciliation module can, for example, converts the flat file data into structured database files to thereby reconcile the data and check for errors. In addition, the reconciliation module can, for example, produce error reports responsive to a comparison of the structured database files. See also FIG. 4b for data flow between the various modules according to an embodiment of the present invention.

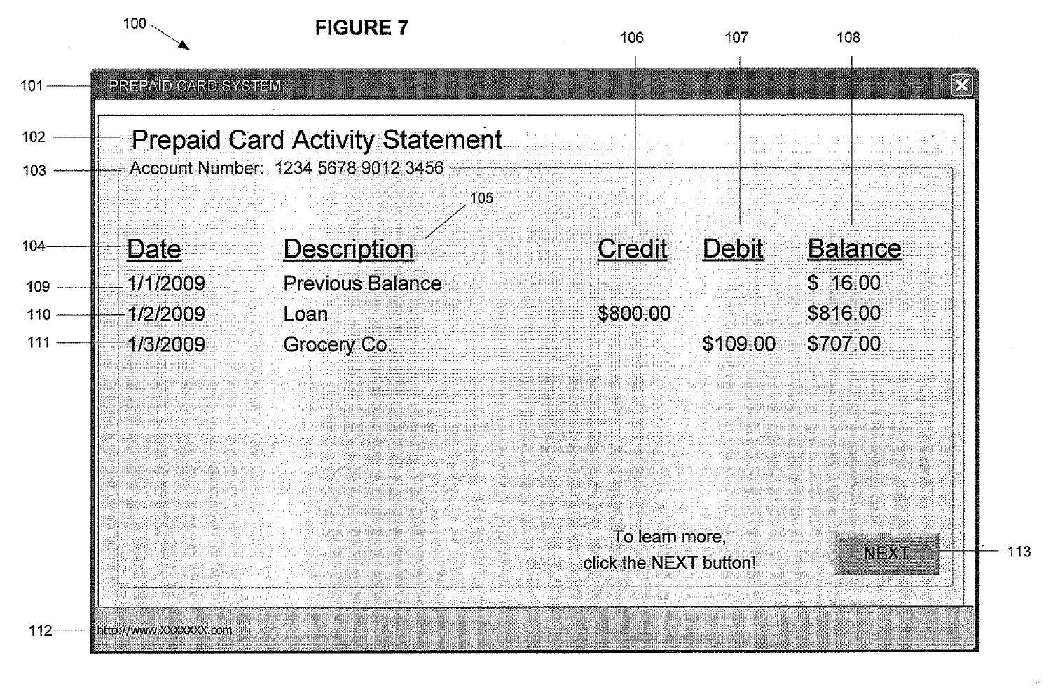

A serial number of a prepaid card (see 94 in FIG. 8A) can include, for example, a Bank Identification Number (BIN) as understood by those skilled in the art. Each card number issued within an open payment network, such as, Visa, MasterCard, and others as understood by those skilled in the art, includes a Bank Identification Number. Each Bank Identification Number is assigned to an issuer, i.e., a lending institution, by the open payment network as understood by those skilled in the art. When the Bank Identification Number is configured with the open payment network, the prepaid card processor, or the destination for authorization and settlement transactions, is designate by the issuer, i.e., the lending institution, as understood by those skilled in the art. According to embodiments of the present invention, the prepaid card taxonomy module 71c can utilize the Bank Identification Number portion of the serial number of a prepaid card to determine the prepaid card processor.

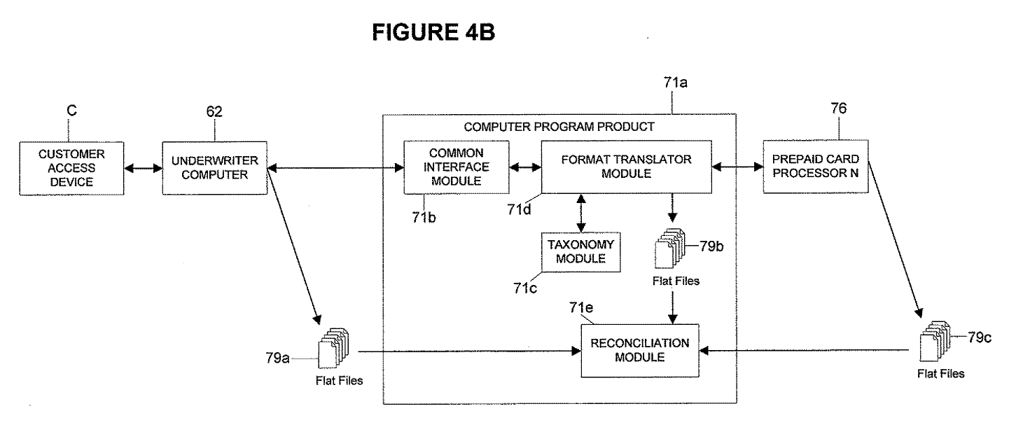

The embodiments of the present invention also include a computer program product, as illustrated in FIG. 5, associated with the bank computer 68, stored on a tangible computer memory media 42, operable on a computer 68, the computer program product comprising a set of instructions 44 that, when executed by the computer, cause the computer to perform various operations. The operations include generating a common interface for information for an approved loan to an underwriter computer from the bank computer when proceeds from the loan are destined for a prepaid card account (block 46). The operations also include determining a prepaid card processor associated with the prepaid card account from the loan information provided through the common interface from the underwriter to the lending institution (block 48). The operations further include invoking the prepaid card processor as one of a plurality of preselected processors available to post the loan proceeds to the prepaid card account (block 50). The operations also include reconciling the information for the approved loan from the underwriter computer with the information from the prepaid card processor (block 52). The operations further include providing security services (block 54), such as permitting only known and verified computer addresses, requiring user name and password, and other such application-level and firewall-level functions, as understood by those skilled in the art.

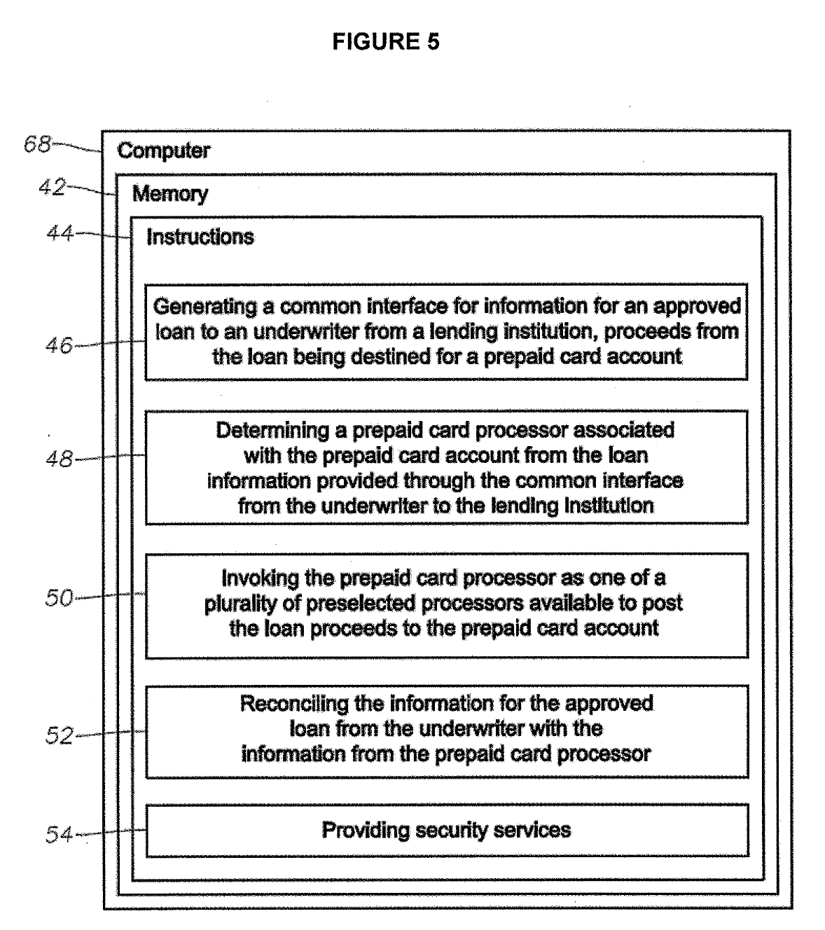

As illustrated in FIG. 6, embodiments of the present invention can include a loan application, e.g., an online loan application for a prepaid card 201, and representations and visual depictions 200 of a loan application on interface devices as understood by those skilled in the art. A loan application 201 can include, for example, applicant information 203, such as a name 204, an address 205, one or more sources 206 and one or more amounts of income 207, a prepaid card account number 208 to receive the loan proceeds, an amount of loan requested 211, and an electronic address 212. The electronic address 212 can be an e-mail address, a phone number that accepts text messages, or other address as understood by those skilled in the art.

FIGS. 8A and 8B illustrate a prepaid card 90, according to an embodiment of the present invention. As understood by those skilled in the art, the prepaid card can have indicia 92, e.g., logos, slogans, source identifiers, of a sponsoring bank and of a prepaid card processor 72, 76; a serial number 94; and expiration date 96. The structures of various types of specific cards, e.g., magnetic stripe 98, type of material, are well known to those skilled in the art and can be used with embodiments of the present invention. Typically, a card 90 is formed from plastic and has a magnetic stripe 98 affixed to the plastic through an application of heat. Those skilled in the art will understand that other embodiments besides a magnetic stripe can include radio frequency identification devices (RFID), smart chips, bar codes, and other similar devices. Embodiments of the present invention can include forming cards or receiving cards already formed.

A magnetic stripe card 90 can store information, or data, e.g., account information, by modifying the magnetism of particles on the magnetic stripe 98 on the card. The information can be read by swiping the card past a reading head, including most point-of-sale hardware, Typically, there are two tracks of information on a magnetic card used for financial transactions, known as tracks 1 and 2. In addition, a third track, known as track 3, can be available for magnetic stripe cards. Tracks 1 and 3, if available, are typically recorded at 210 bits per inch, while track 2 typically has a recording density of 75 bits per inch. Track 2, as typically encoded, was developed by the American Bankers Association (ABA) provides for 37 numeric data characters, including up to 19 digits for a primary account number (including a Bank Identification Number as understood by those skilled in the art), an expiration date, a service code, and discretionary verification data, such as, a Personal Identification Number, or PIN. The information on the card can be used, for example, to facilitate a transaction. For example, when the card 90 is swiped through a reader, the information on the magnetic stripe 98 is read and processed by the reader. The reader can then communicate through an electronic communications network 66 to, for example, a prepaid card processor 72, 76. The card reader, e.g., point of sale, communicates the account information as read from the card, as well as other information, such as, an amount of a proposed transaction for approval. The other information, for example, can be entered by merchant personnel (e.g., an amount of the transaction), the consumer (e.g., a PIN, or security code), or bank personnel (e.g., a security approval). The prepaid card processor 72, 76 can then utilize the account information and other information to authorize or reject a purchase by, for example, determining whether a proposed purchase by the consumer is less than an amount of funds remaining on the card. Moreover, optional security measures, including, for example, a mismatch between a PIN supplied by the consumer and a PIN stored on the card or in a database, can result in the rejection of a proposed transaction. The prepaid card processor 72, 76 then perform certain functions, including responding to the authorization request so that a point-of-sale displays an indication of approval or rejection, resulting in a visual depiction to a merchant of the approval or rejection of the proposed transaction. Also, prepaid card processor 72, 76 can, for example, write data to a database to record a transaction, to debit available funds from an account associated with the prepaid card 90, and to credit directly or indirectly a merchant for a purchase. In addition to purchase authorization, embodiments of the present invention also can include customer inquiries into recent transactions or a balance inquiry, i.e., an amount of remaining value associated with the prepaid card.

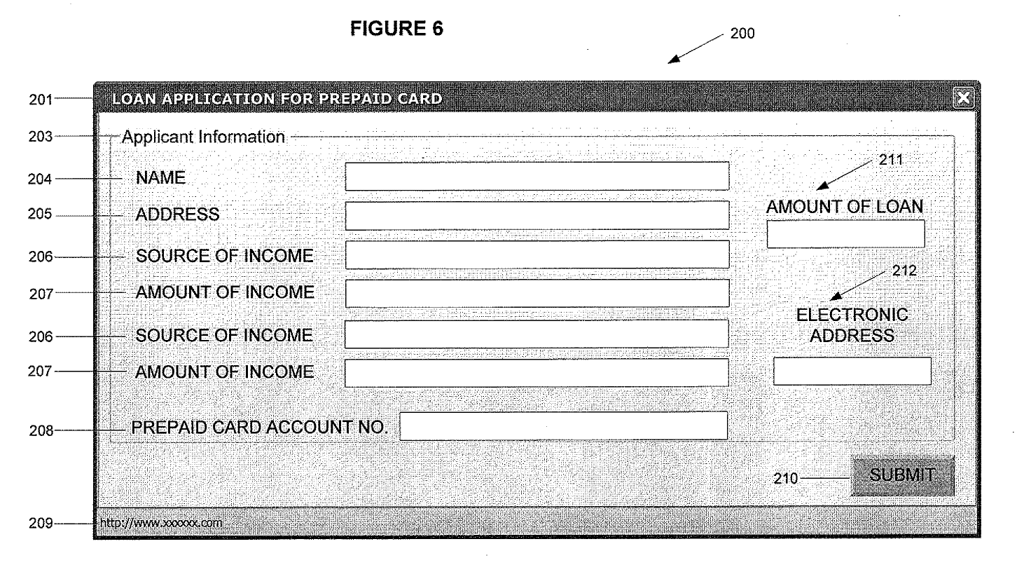

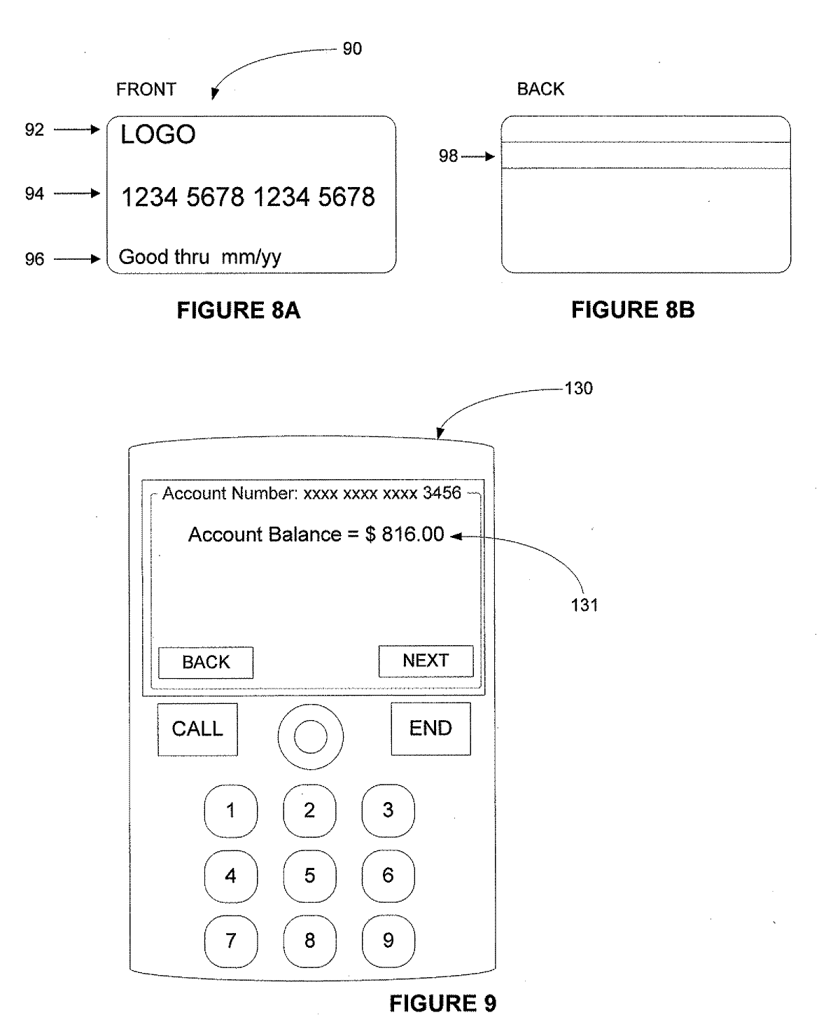

Embodiments of the present invention can also include, for example, various interface access devices. An interface access device can include, for example, a point of sale apparatus at a merchant. An interface access device can also include, for example, a website that accepts the prepaid card serial number 94, or account number, either through a reader or through manual entry. The website can then display to the consumer, for example, a balance associated with the card or recent transactions. Embodiments of other interface access devices can further include, for example, a mobile phone or personal digital assistant (PDA) 130 for sending text messages 131 to thereby provide a visual representation of a loan amount being posted to a prepaid card. See FIG. 9. Embodiments can also include, for example, a telephone interface, including a computerized interactive voice response unit (IVRU). In another embodiment, a customer interface access computer can be, for example, an electronic kiosk computer positioned remote from the merchant point of sale and remote from and in communication with the prepaid card processor 72, 76 via a communications network 66. The electronic kiosk computer, for example, can include a processor, a memory element, a display device, a user interface device, and a printer. According to exemplary embodiments of the present invention, the kiosk computer can be operated and controlled by a merchant, a lending institution, or a prepaid card processor 72, 76. In embodiments of the present invention where an electronic kiosk computer is used, the response to the query can include, for example, displaying recent transaction data on a display device, or screen, of the kiosk computer. See also FIG. 7. According to embodiments of the present invention, the electronic kiosk can be, for example, of similar construction and operation to kiosks used by airlines to purchase tickets and print boarding passes at an airport. Embodiments of various access devices can allow, for example, a consumer, a merchant, or a bank to interact with a display and/or user interface (e.g., keypad, keyboard) to perform certain additional operations, to store certain data, and make changes to data content associated with an account 74, 78 or with a proposed transaction.

As illustrated in FIG. 7, embodiments of interface access devices advantageously provide a representation of account activity 100, including a transaction 111 in which value associated with a prepaid card is exchanged for goods. In addition, a representation of account activity can include a posting of a loan amount to the prepaid card 110. The visual depiction of a transaction can include a date 104 and time of the transaction, an amount of credit to the account 106, an amount of debit from the account 107, an account balance 108, and a transaction description 105. Embodiments of interface access devices also advantageously provide a visual depiction of an amount of value associated with a card so that the amount of value can be exchanged for goods. Embodiments can include, for example, visual depictions and representations displayed on access interface devices to consumers, point-of-sale devices for merchants, and computer servers for bank personnel. In addition, embodiments can include, for example, printed representations, such as, a statement mailed to the consumer detailing transaction history and balance information, a consumer statement printed at a kiosk, or an electronic statement available as, for example, an e-mail or through a website, printed by the consumer.

A person having ordinary skill in the art will recognize that various types of memory are readable by a computer such as described herein, e.g., underwriter computer, bank computer, prepaid card processors, or other computers with embodiments of the present invention. Examples of computer readable media include but are not limited to: nonvolatile, hard-coded type media such as read only memories (ROMs), CD-ROMs, and DVD-ROMs, or erasable, electrically programmable read only memories (EEPROMs), recordable type media such as floppy disks, hard disk drives, CD-R/RWs, DVD-RAMs, DVD-R/RWs, DVD+R/RWs, flash drives, memory sticks, and other newer types of memories, and transmission type media such as digital and analog communication links. For example, such media can include operating instructions, as well as instructions related to the system and the method steps described above and can operate on a computer. It will be understood by those skilled in the art that such media can be at other locations instead of or in addition to the locations described to store program products, e.g., including software, thereon.

This application claims priority to and the benefit of U.S. Provisional Patent Application No. 61/029,975, titled “Methods to Advance Loan Proceeds on Prepaid Cards, Associated Systems and Computer Program Productst”, filed on Feb. 20, 2008, incorporated herein by reference in its entirety. This application relates to: U.S. Provisional Patent Application Ser. No. 61/052,454, by Sorbe et al., titled “Transfer Account Systems, Computer Program Products, and Methods to Prioritize Payments from Preselected Bank Account” filed May 12, 2008; U.S. Provisional Patent Application Ser. No. 61/042,612, by Ahlers et al., titled “System, Program Product, and Associated Methods To Autodraw for Micro-Credit Attached to a Prepaid Card” filed on Apr. 4, 2008; U.S. Provisional Patent Application Ser. No. 61/042,624, by Crowe et al., titled “System, Program Product, and Method To Authorize Draw for Retailer Optimization” filed on Apr. 4, 2008; U.S. Provisional Patent Application Ser. No. 61/032,750, by Ahlers et al., titled “Methods, Program Product, and System for Micro-Loan Management” filed on Feb. 29, 2008; U.S. Provisional Patent Application Ser. No. 61/060,559, by Galit et al., titled “Methods, Program Product, and System to Enhance Banking Terms Over Time” filed on Jun. 11, 2008; U.S. Provisional Patent Application Ser. No. 61/082,863, by Ahlers et al., titled “System, Program Product, and Method For Debit Card and Checking Account Autodraw” filed on Jul. 23, 2008; U.S. Provisional Patent Application Ser. No. 61/053,056, by Galit et al., titled “System, Program Product, and Method For Loading a Loan On a Pre-Paid Card” filed on May 14, 2008, all of which are each incorporated herein by reference in their entireties. This application also relates to: U.S. patent application Ser. No. 12/338,584, by Sorbe et al., titled “Transfer Account Systems, Computer Program Products, and Computer-Implemented Methods to Prioritize Payments from Preselected Bank Account” filed Dec. 18, 2008; U.S. patent application Ser. No. 12/338,645, by Sorbe et al., titled “Transfer Account Systems, Computer Program Products, and Computer-Implemented Methods to Prioritize Payments from Preselected Bank Account” filed Dec. 18, 2008; U.S. patent application Ser. No. 12/338,684, by Ahlers et al., titled “Computer-Implemented Methods, Program Product, and System for Micro-Loan Management” filed on Dec. 18, 2008; PCT/US08/87660 by Ahlers et al., titled “Computer-Implemented Methods, Program Product, and System for Micro-Loan Management” filed on Dec. 19, 2008; U.S. patent application Ser. No. 12/338,712, by Galit et al., titled “Computer-Implemented Methods, Program Product, and System to Enhance Banking Terms Over Time” filed on Dec. 18, 2008; and PCT/JS08/87689 by Galit et al., titled “Computer-Implemented Methods, Program Product, and System to Enhance Banking Terms Over Time” filed on Dec. 19, 2008, all of which are each incorporated herein by reference in their entireties.

Many modifications and other embodiments of the invention will come to the mind of one skilled in the art having the benefit of the teachings presented in the foregoing descriptions and the associated drawings. Therefore, it is to be understood that the invention is not to be limited to the illustrated embodiments disclosed, and that modifications and other embodiments are intended to be included within the scope of the appended claims.

That claimed is:

1. A system for advancing loan proceeds on prepaid card accounts, the system comprising:
a first computer associated with a lending institution defining a bank computer, the bank computer having memory, being associated with the electronic communications network, being positioned to receive and process loan information from a second computer associated with an underwriter defining an underwriter computer, and being positioned to provide loan posting information to a plurality of third computers associated with customer prepaid card accounts defining prepaid card processors, the loan information responsive to a loan application; and
a computer program product associated with the bank computer, stored on a tangible computer memory media, operable on a computer, and used to advance loan proceeds to a prepaid card account, the computer program product including:
a common interface module associated with the bank computer, stored on a tangible computer memory media and operable on a computer, the common interface module comprising a set of instructions that, when executed by the computer, cause the computer to perform the operation of:
receiving data for an approved loan from one or more underwriter computers, proceeds from the loan being destined for a prepaid card account,
a prepaid card taxonomy module associated with the bank computer, stored on a tangible computer memory media and operable on a computer, the prepaid card taxonomy module comprising a set of instructions that, when executed by the computer, cause the computer to perform the operations of:
classifying prepaid cards according to an associated prepaid card processor;
maintaining a database that associates prepaid cards with prepaid card processors; and
determining a prepaid card processor associated with the prepaid card account from loan data provided through the common interface module from the underwriter computer responsive to a prepaid card serial number,
a format translator module associated with the bank computer, stored on a tangible computer memory media and operable on a computer, the format translator module comprising a set of instructions that, when executed by the computer, cause the computer to perform the operations of:
invoking the associated prepaid card processor for a given prepaid card responsive to the determination of the taxonomy module;
converting the loan data received by the common interface module into a processor-specific instruction; and
communicating the converted loan data to the prepaid card processor to post the loan proceeds to the prepaid card account so that the loan application is converted into a prepaid card having an associated value and being capable of purchasing goods, and
a reconciliation module associated with the bank computer, stored on a tangible computer memory media and operable on a computer, the reconciliation module comprising a set of instructions that, when executed by the computer, cause the computer to perform the operations of:
receiving data for the approved loan from the underwriter computer and the prepaid card processor, and
comparing data for the approved loan from the underwriter computer and the prepaid card processor to thereby check for errors.

2. A system of claim 1, wherein the common interface module includes a single request accepting an extensive mark-up language (XML) payload, the payload including a section for message content, a section for a description of the message content, and a section for exception information pertaining to the message.

3. A system of claim 1, wherein a serial number of a prepaid card includes a Bank Identification Number, wherein a lending instruction designates the prepaid card processor for the Bank Identification Number at a configuration of the Bank Identification Number, and wherein the prepaid card taxonomy module utilizes the Bank Identification Number portion of the serial number of a prepaid card to determine the prepaid card processor.

4. A system of claim 1, wherein the format translator module further comprises a set of instructions that, when executed by the computer, cause the computer to perform the operation of: converting a first data format associated with the common interface module into one or more second data formats, each of the one or more second data formats associated with a prepaid card processor.

5. A system of claim 1, wherein the reconciliation module further comprises a set of instructions that, when executed by the computer, cause the computer to perform the operation of:
receiving loan data in flat files from the underwriter computer, from the prepaid card processor, and from the format translator module;
converting the flat file data into structured database files; and
producing error reports responsive to a comparison of the structured database files.

6. A system of claim 1, wherein the computer program product associated with the bank computer further comprises a set of instructions that, when executed by the computer, cause the computer to perform the operation of:
sending an electronic message to an address associated with the loan application responsive to the loan proceeds being posted to thereby provide a visual depiction of a value being added to the prepaid card.

7. A computer program product associated with a bank computer, stored on a tangible computer memory media, operable on a computer, and used to advance loan proceeds to a prepaid card account, the computer program product comprising a set of instructions that, when executed by the computer, cause the computer to perform the operations of:
generating, by a first computer associated with a lending institution defining a bank computer, a common interface for information for an approved loan to a second computer associated with an underwriter defining an underwriter computer, the loan information responsive to a loan application, proceeds from the loan being destined for a prepaid card account;
determining a prepaid card processor associated with the prepaid card account from the loan information provided through the common interface from the underwriter computer to the lending institution computer responsive to a prepaid card serial number;
invoking the prepaid card processor as one of a plurality of preselected processors available to post the loan proceeds to the prepaid card account to thereby convert the loan application into a prepaid card having an associated value and being capable of purchasing goods; and
reconciling the information for the approved loan from the underwriter computer with the information from the prepaid card processor.

8. A computer program product of claim 7, wherein the common interface includes a single request accepting an extensive mark-up language (XML) payload, the payload including a section for message content, a section for a description of the message content, and a section for exception information pertaining to the message.

9. A computer program product of claim 7, wherein determining a prepaid card processor associated with the prepaid card account from the loan information provided through the common interface from the underwriter computer to the lending institution computer includes utilizing a database of prepaid card files that associates prepaid cards with prepaid card processors.

10. A computer program product of claim 7, wherein the plurality of preselected card processors comprises card data processors positioned to receive and process card data responsive to processor-specific interfaces, and wherein the step of invoking the prepaid card processor comprises utilizing a processor-specific interface so that a first data format is converted into a second data format to thereby enable the posting of the loan proceeds to the prepaid card.

11. A computer program product of claim 7, wherein determining a prepaid card processor associated with the prepaid card account from the loan information provided through the common interface from the underwriter computer to the lending institution computer includes utilizing a Bank Identification Number portion of a serial number of the prepaid card to determine the prepaid card processor.

12. A computer program product of claim 7, further comprising a set of instructions that, when executed by the computer, cause the computer to perform the operation of:
sending an electronic message to an address associated with the loan application responsive to the loan proceeds being posted to thereby provide a visual depiction of a value being added to the prepaid card.

13. A computer program product of claim 7, further comprising a set of instructions that, when executed by the computer, cause the computer to perform the operation of:
displaying an account activity statement, including a purchase, to thereby provide a visual depiction of a value associated with the prepaid card being exchanged for goods.

14. A computer-implemented method of advancing loan proceeds on prepaid cards, the computer-implemented method comprising:
generating, by a first computer associated with a lending institution defining a bank computer, a common interface for information for an approved loan to a second computer associated with an underwriter defining an underwriter computer, the loan information responsive to a loan application, proceeds from the loan being destined for a prepaid card account;
determining by the bank computer a prepaid card processor associated with the prepaid card account from the loan information provided through the common interface from the underwriter computer to the lending institution computer responsive to a prepaid card serial number;
invoking the prepaid card processor as one of a plurality of preselected processors available to post the loan proceeds to the prepaid card account by the bank computer to thereby convert the loan application into a prepaid card having an associated value and being capable of purchasing goods; and
reconciling the information for the approved loan from the underwriter computer with the information from the prepaid card processor by the bank computer.

15. A computer-implemented method of claim 14, wherein the common interface includes a single request accepting an extensive mark-up language (XML) payload, the payload including a section for message content, a section for a description of the message content, and a section for exception information pertaining to the message.

16. A computer-implemented method of claim 14, further comprising:
providing security services, including permitting only known computer addresses and requiring a user name and a password.

17. A computer-implemented method of claim 14, wherein the plurality of preselected card processors comprises card data processors positioned to receive and process card data responsive to processor-specific interfaces, and wherein the step of invoking the prepaid card processor comprises utilizing a processor-specific interface so that a first data format is converted into a second data format to thereby enable the posting of the loan proceeds to the prepaid card.

18. A computer-implemented method of claim 14, wherein the step of determining by the bank computer a prepaid card processor associated with the prepaid card account from the loan information includes utilizing a Bank Identification Number portion of a serial number of the prepaid card to determine the prepaid card processor.

19. A computer-implemented method of claim 14, further comprising:
sending an electronic message to an address associated with the loan application responsive to the loan proceeds being posted to thereby provide a visual depiction of a value being added to the prepaid card.

20. A computer-implemented method of claim 14, further comprising:
displaying an account activity statement, including a purchase, to thereby provide a visual depiction of a value associated with the prepaid card being exchanged for goods.
